(19) United States
(12) Patent Application Publication
(10) Pub. No.: US 2015/0253901 A1
(43) Pub. Date: Sep. 10, 2015

(54) MANUFACTURING METHOD FOR SINGLE-SIDED MULTI-LAYER CIRCUIT PATTERN FOR TOUCH PANEL

(71) Applicant: CN Innovations Limited, Hong Kong (CN)

(72) Inventor: Winston CHAN, Hong Kong (CN)

(21) Appl. No.: 14/623,172

(22) Filed: Feb. 16, 2015

Related U.S. Application Data
(60) Provisional application No. 61/949,251, filed on Mar. 7, 2014.

(51) Int. Cl. G06F 3/044; C03C 23/00; C03C 17/36

(52) U.S. Cl. CPC G06F 3/044; C03C 17/3639; C03C 17/3655; C03C 17/3668; C03C 23/0025

(57) ABSTRACT

A manufacturing method for a single-sided multi-layer mutual capacitance touch circuit structure uses selective laser processing. The structure that is created includes two conducting layers on the same side of a transparent non-conducting substrate, with isolation substructures providing the required electrical isolation at the cross-over points of the circuits and electrodes on the two conducting layers. By using selective laser processing, the structure is selectively etched and cures any part of any layer in a multi-layer structure without damaging neighboring regions and other layers.

### RELATED APPLICATION

This application claims priority to U.S. Provisional Application Ser. No. 61/949,251 filed on Mar. 7, 2014, the contents which are hereby incorporated by reference in their entirety.

### FIELD

The present subject matter relates to the field of electronics and, more particularly, to the field of touch panels based on a mutual capacitance sensing approach, and associated manufacturing methods, device structures, and designs.

### BACKGROUND

A touch panel is an electronic panel that provides a user with the ability to interact and communicate with a device attached to the touch panel by simply touching a particular area of a glass screen, or an icon displayed below a screen. A subsystem can detect the user's touch and perform a related control function. Today, electronic devices are one of the major drivers for continuous pursuit of high performance touch panels because many electronic devices, portable devices in particular, feature touch panel controls in place of push-buttons or keyboard type input devices.

There are a variety of technologies used in systems equipped with touch panels to determine the position, relative to a screen, of a user's finger touching the panel. One of the more current and popular technologies uses a mutual capacitance sensing approach. For mutual capacitance sensing, an array of sensor electrodes consisting of so-called transmitter and receiver electrodes in close proximity to one another are integrated onto a transparent, non-conducting substrate. When a voltage is applied to the transmitter, a mutual capacitance is induced between the transmitter and receiver. Bringing a finger or conductive stylus close to the surface of the sensor changes the local electrostatic field, which reduces the mutual capacitance. The capacitance change at every individual point on the array is then measured to accurately determine the touch location. As such, in order to maintain a mutual capacitance, the transmitter and receiver electrodes must be electrically isolated, which is well known to a person having ordinary skill in the circuit manufacturing art.

To achieve a touch panel based on the mutual capacitance approach, a layer of arrayed electrodes (transmitter electrodes) are placed on one side of a transparent non-conducting substrate; while another layer of arrayed electrodes (receiver electrodes) are placed on the opposite side. According to this arrangement, the transmitters and receivers remain electrical isolated, known as the “two-sided panel”. However, two-sided panels suffer from a heavier weight, a thicker body and also a higher material cost. These panels cannot meet the ever-growing demand for a lighter, thinner and cheaper high-performance touch panel.

As such, a single-sided panel has been developed, in which the orthogonal transmitter and receiver electrodes are implemented on the same side of a transparent substrate, yet kept isolated from one another. Developing a single-sided panel is accomplished by either arranging all transmitter and receiver electrodes on the same plane or on multiple layers. For the former, isolation is implemented by arranging continuous parallel electrodes (transmitters) in one direction, and arranging another set of electrode segments (receivers) located between the former parallel electrodes (transmitters) without contacting the electrodes (transmitters). Obviously, such configuration requires a much larger space for each sensing element (transmitter and receiver), that in turn limits the overall spatial resolution and position precision of the touch panel. An alternative to this single-sided, single-layer panel is a single-side, multi-layer panel, in which the orthogonal electrodes are not coplanar but are in separated and electrically isolated layers on the same side of the non-conducting substrate. This preserves the electrode mutual electrical isolation while avoiding complicated in circuitry and also occupying less space.

The current circuit manufacturing art including a single-sided, multi-layer, mutual capacitance touch screen adopts the integrated circuit (IC) fabrication approach involving photolithography, passivation, etching, and developing processes. A typical example includes a circuit of indium tin oxide (ITO) that is first prepared on an ITO covered glass substrate. Next, the ITO bridge retention, overcoat, and photoresist coating form an insulating layer. Additionally, another layer of ITO is deposited on which the desired touch pattern circuit is produced. Finally, metal is deposited by using physical vapor deposition and insulating leads are shaped and formed. In the abovementioned process, photolithographic processes and etching are required in each step. The process is not only complicated but also very costly. Further, this process consumes a large amount of chemicals and materials, and at the same time generates a large amount of chemical waste which raises a serious concern to both human health and the environment. Moreover, multiple etching processes can easily damage other device components and functional layers. A simpler, cheaper, material-saving, but less harmful manufacturing process is definitely needed to make the production of touch panels a less pollution creating and ecologically appropriate endeavor.

### SUMMARY

It is an object of the present subject matter to produce single-sided, multi-layer, touch circuit structures and panels in a cleaner manner by using a method that requires no chemical etching, while producing panels including a width commensurate with the width of panels produced using current circuit manufacturing art and involving photolithography and etching.

The present subject matter discloses a new method of preparing a single-sided, multi-layer, mutual capacitance touch circuit structure and panel. This method uses a selective laser processing technique to achieve the desired sensing circuitry. Laser processes have been applied in the manufacture of touch panels, but have not been used for producing circuits for the functional areas of single-sided, multi-layer, capacitive touch panels. In the present subject matter, selective laser processes are first used to construct functional bridges and connection points of multi-layer conducting circuits in a single-sided, multi-layer, mutual capacitance touch panel. The present subject matter does not involve complicated and costly steps or a chemical etching processes that produce large amounts of chemical waste.

Rather than using two conducting layers separated by a non-conducting layer, the present subject matter uses two conducting layers and selective laser etching to create one layer of electrodes for sensing an X position and another layer of electrodes for sensing a Y position.

Instead of the middle non-conducting layer used in contemporary single-sided, multi-layer, panel production, the present subject matter makes use of two conducting layers shaped into electrodes by selective laser etching, and also non-conducting inserts for creating insulating sub-structures that provide the required isolation at specific cross-over locations on the two layers. These sub-structures are implemented without using wet chemistry.

The layer thicknesses are commensurate with those of other implementation structures and methods. The amount of material etched away, however, is far less than that the material etched using other structures and methods.

In one embodiment, selective laser etching is applied to selectively etch out part of a conducting layer in any form or shape (e.g. line, square, circle) in order to create an insulation gap for electrical isolation without damaging the neighboring region. Such selective laser etching is performed on a conducting layer sitting on a plane surface or an irregular surface. In another non-limiting embodiment, selective laser etching is applied to selectively etch out a certain part of any layer in a multi-layer structure without damaging neighboring regions and other layers. In a third non-limiting embodiment, selective laser curing is applied to selectively cure a certain part of any layer in a multi-layer structure without damaging neighboring regions and other layers. In each of these embodiments, the end result is accomplished using far simpler, cleaner and less pollution causing activities than other methods.

### BRIEF DESCRIPTION OF THE DRAWINGS

FIG. 1 shows the schematic diagram of a single-sided multi-layer touch screen module.

FIG. 2 shows the schematic diagram of a single-sided multi-layer touch screen pattern.

FIG. 3 shows the cross sectional views of the touch panel along X-X and Y-Y directions.

FIG. 4 shows the cross-sectional views of the touch panel at different processing steps during its manufacturing process.

FIG. 5 shows the cross-sectional view of the touch pattern in Step 2 of the manufacturing process: Formation of two ITO gaps by laser etching.

FIG. 6 shows the cross-sectional view of the touch pattern in Step 3 of the manufacturing process: Inkjet printing of insulating block.

FIG. 7 shows the cross-sectional view of the touch pattern in Step 4 of the manufacturing process: Physical vapor deposition of the second layer of ITO.

FIG. 8 shows the cross-sectional view of the touch pattern in Step 6 of the manufacturing process: Laser patterning.

### DETAILED DESCRIPTION

The present subject matter is directed to a method of producing single-sided, multi-layer, mutual capacitance touch circuit structures and panels. Such a touch circuit structure typically has a set of electrodes extending in an X direction and a second set of electrodes extending in a Y direction. These mutually perpendicular electrodes are electrically isolated from one another. It is the detection of a change in mutual capacitance between portions of the two sets of electrodes that determine the position of a finger touching the panel.

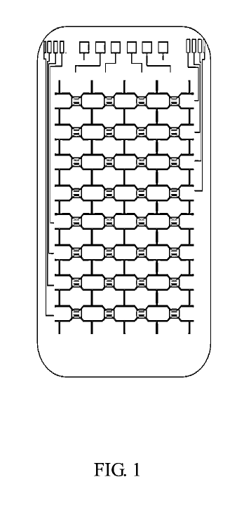

FIG. 1 depicts a schematic diagram of a single-sided, multi-layer touch screen. More specifically, this embodiment shows an example of the possible forms of a product where the present subject matter is implemented. This process does not impose any limit or restriction to the scope of the application of the present subject matter and also the product form thereof.

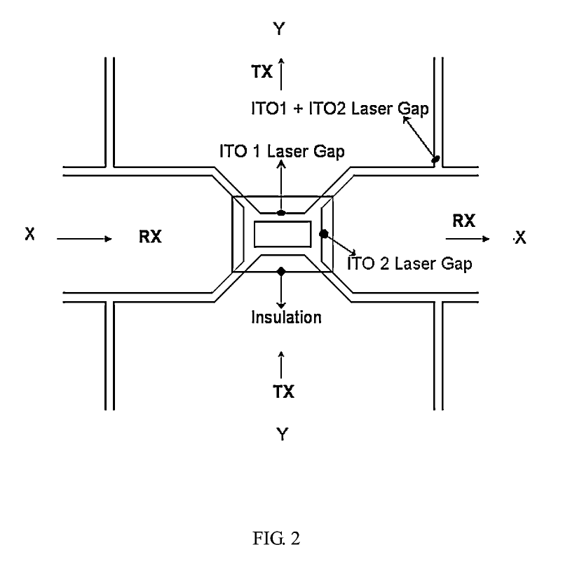

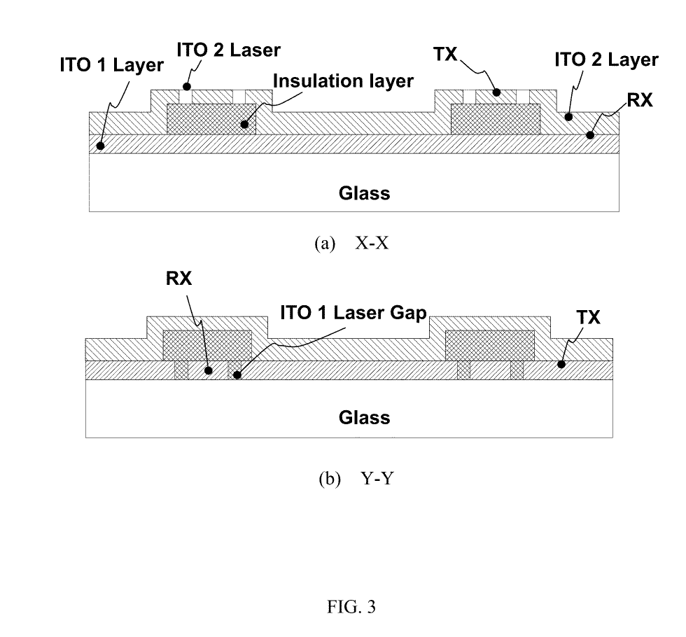

FIG. 2 shows the top view of the schematic diagram of a process pattern by using the present subject matter for a single-sided, multi-layer touch panel. FIGS. 3a and FIG. 3b show the cross-sectional views of the process pattern along an X-X direction and a Y-Y direction, respectively. As shown, conducting paths are established in both X and Y directions; while the paths are electrically isolated from one another. The circuit pattern of FIG. 2 exemplifies a possible pattern that is fabricated and does not impose any limit or restriction to another process pattern.

In this embodiment of the present subject matter, a circuit pattern for a single-sided, multi-layer, mutual capacitance touch panel is prepared. The present subject matter involves fewer processing steps than traditional methods. Additionally, this circuit pattern significantly enhances the utilization of the materials, leading to a cost-effective and environmental friendly manufacturing process for mutual capacitance touch panels.

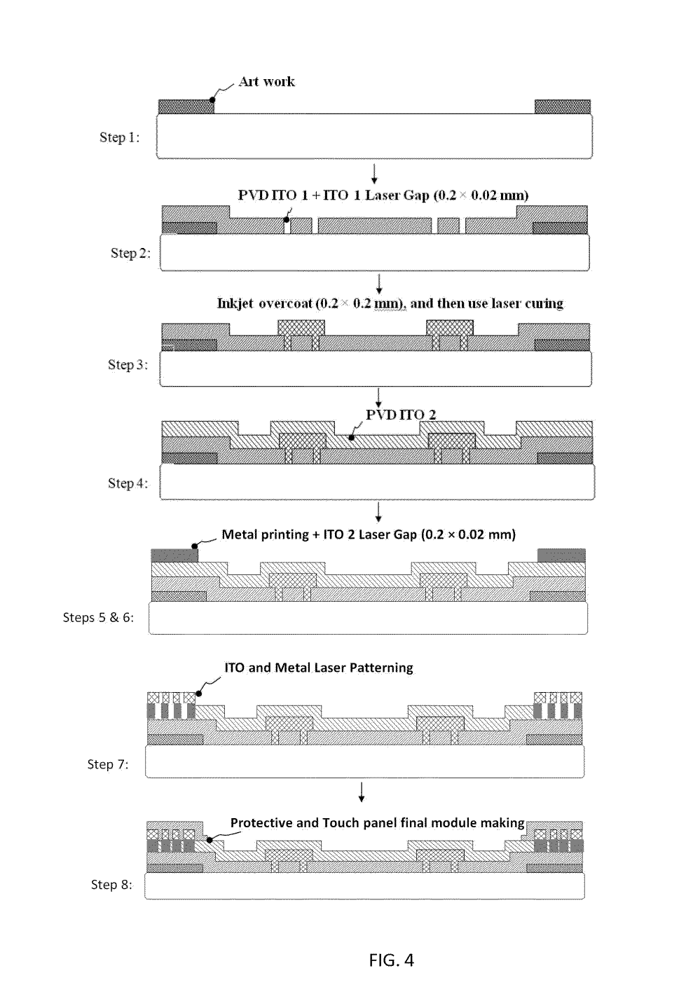

In the first processing step, an artwork is printed on a strengthened glass substrate. The thickness of the artwork can range from 1-80 μm, particularly about 22 μm. Material for printing the artwork includes all colors and types of ink for printing. FIG. 4 (Step 1) shows the cross-sectional view of the pattern after this processing step.

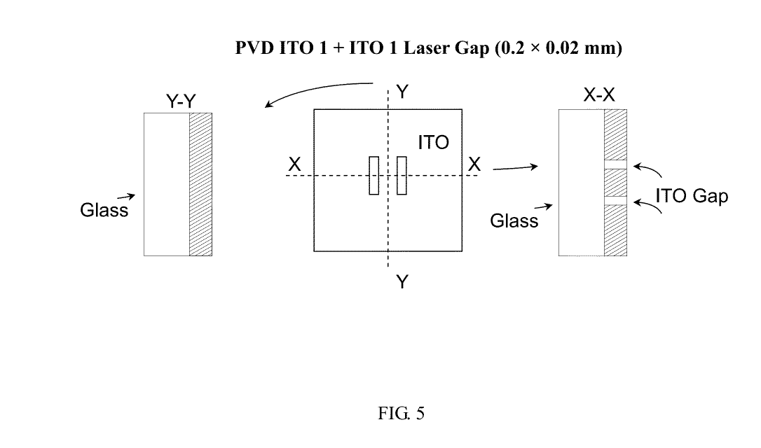

In the second processing step, the first transparent conducting layer is deposited on the entire glass substrate including the artwork (in particular by, but not limited to, physical vapor deposition). Selective laser patterning is then applied by selective laser etching and produces two parallel gaps. The length of the parallel gaps range from 0.05-0.5 mm, in particular about 0.16 mm. The width ranges from 0.001-0.3 mm, particularly about 0.02 mm. The distance between the two parallel gaps range from 0.01-0.5 mm, more preferably about 0.05 mm. The sizes of the gaps and the distances between the two gaps are adjusted based on the touch circuit. Transparent conductive materials include indium tin oxide (ITO), zinc oxide (ZnO₂), carbon nanotubes, and silver nanowires, and any other conducting material having a comparable electrical conductivity thereof. The thickness of the transparent conducting layer can range from 10-600 nm, in particular approximately 26 nm. FIG. 4 (Step 2) shows the cross-sectional view of the pattern after this processing step. FIG. 5 shows the cross-sectional cut of the touch pattern along the X-X and the Y-Y directions.

A conventional circuit manufacturing process requires the removal of all of the conducting layers other than the conducting layer being etched and a bridge area. Furthermore, in conventional circuit manufacturing a large amount of chemical waste is generated. According to the present subject matter, the majority of the conducting layer located on regions that have not been etched are not removed and the amount of chemical waste that is produced is significantly less than the amount of waste generated using a conventional process. By performing selective laser etching, the manufacturing process is greatly simplified, consumes less chemicals, requires less processing time, and produces a single-sided, multi-layer pattern on various substrates including a three-dimensional lens and flexible materials.

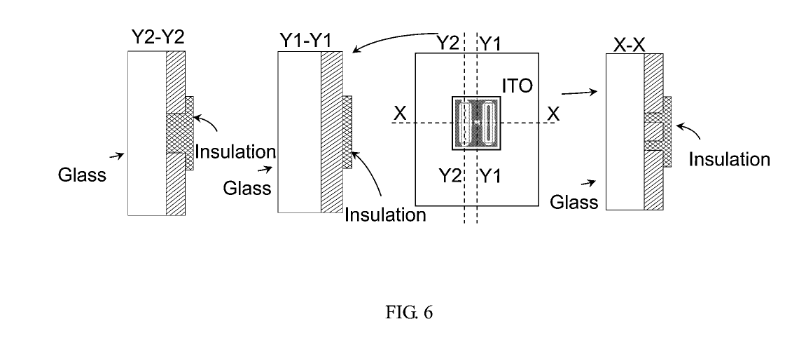

In the third processing step, an insulating layer is coated, in one way by, but not limited to, spin coating, to cover the entire glass substrate. The thickness of the insulating layer ranges from 0.5-7 μm. The insulating layer is pre-cured at 100° C. for 5 min. The insulating layer is then cured by UV laser exposure to form an insulation block on top of the gaps of the first transparent conductive oxide layer produced by the selective laser etching in the second processing step. The size of the insulating block can range from 0.05-0.6 mm×0.05-0.6 mm, in particular about 0.1 mm×0.2 mm. After laser exposure, a development process is used to remove excess insulating material. The thickness of the insulating block can range from 0.5-7 μm, particularly about 2 μm. Alternatively, the insulating block is produced using inkjet printing to print the insulating blocks directly over the gaps on the first transparent conductive oxide layer produced by the laser etching of the second processing step. The size of the inkjet-printed insulating block can range from 0.05-1 mm×0.05-1 mm, in particular about 0.2 mm×0.3 mm. After inkjet printing, the insulating block is cured by UV laser exposure or a UV lamp, and the size is refined by laser etching ranging from 0.05-0.6 mm×0.05-0.6 mm, alternatively about 0.1 mm×0.2 mm. If the spatial resolution of inkjet printing is high and accurate enough to print the exact size of the insulating block, the block does not need to be refined by laser etching, and can be cured by a UV lamp directly. Materials of the insulating block include a light sensitive insulating photoresist such as a silicon-based resin or an acrylic-based resin, and any insulating and transparent materials that can be used for inkjet printing. FIG. 4 (Step 3) shows the cross-sectional view of the process pattern after this processing step. FIG. 6 shows the cross-sectional view of the pattern along X-X and Y-Y directions.

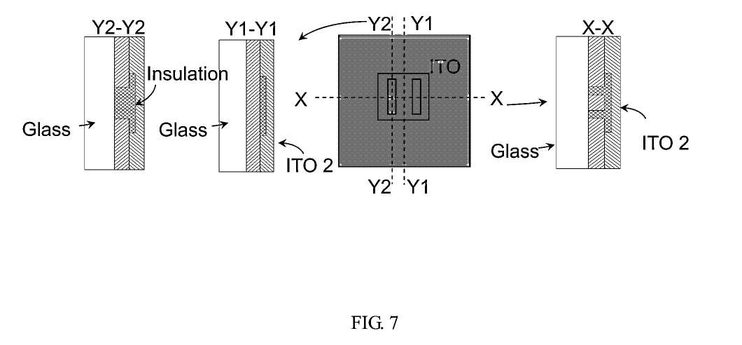

In the fourth processing step, the second transparent conducting layer is deposited. The second layer completely covers the first transparent conducting layer and the insulating block. Transparent conductive materials can be selected from ITO, ZnO₂, carbon nanotubes, and silver nanowires, and any other conducting material bearing comparable electrical conductivity. The thickness of the transparent conducting layer can range from 10-600 nm, particularly about 26 nm. FIG. 4 (Step 4) shows the cross-sectional view of the process pattern after this processing step. FIG. 7 shows the cross-sectional view of the pattern along X-X and Y-Y directions.

In the fifth processing step, metal layers are deposited on the metal leads region located at the edges of the process pattern. The thickness of the metal layer can range from 0.01-15 μm, in particular about 3 μm. Materials for the metal layer include low resistance materials such as silver paste, copper paste, and carbon paste, and any other materials bearing a comparable electrical conductivity. FIG. 4 (Step 5) shows the cross-sectional view of the touch panel after this processing step.

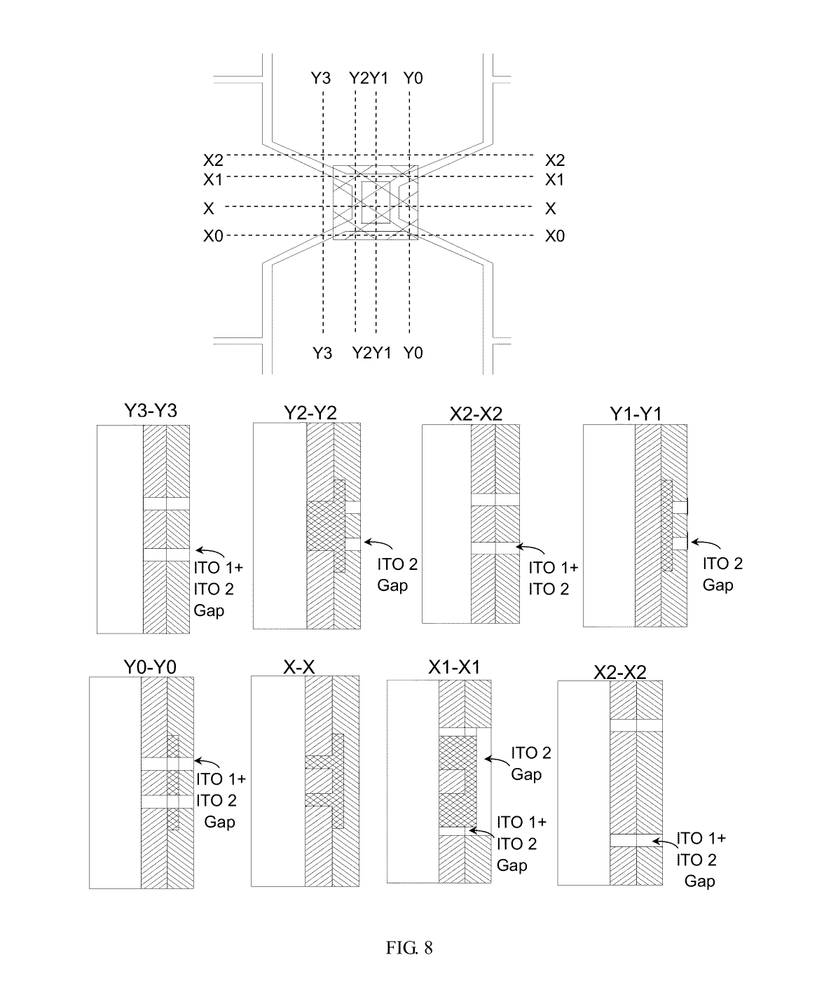

In the sixth processing step, laser etching is used to create additional parallel gaps on the second transparent conducting layer produced in the fourth processing step. The laser produces selective etching in any particular layer or multi-layers. The length of the parallel gaps can range from 0.05-0.5 mm, particularly about 0.16 mm. The width can range from 0.001-0.3 mm, alternatively about 0.02 mm. The distance between the two parallel gaps can range from 0.01-0.5 mm, in particular about 0.05 mm. The size of the gap and the distance between the two gaps are adjusted based on the touch circuit. Selective layer etching is used on the second transparent conducting layer at the central region of the insulating layer produced by the third processing step. In this embodiment, only the conducting layer located above the insulating layer is etched and the conducting layer located below the insulating layer remains intact. FIG. 4 (Step 6) shows the cross-sectional view of the process pattern after this processing step. FIG. 8 shows the cross-sectional view of the pattern along X-X and Y-Y directions.

In the seventh processing step, metal leads and a touch pattern are simultaneously laser etched to produce the required patterning for the touch circuit. FIG. 4 (Step 7) shows the cross-sectional view of the process pattern after this processing step.

In the eighth processing step, a protective layer is added. The protective layer of the insulating region is an anti-reflection (AR) coating. Materials of the protective layer are photo-insulating materials such as silicon dioxide (SiO₂) or other insulating materials. The thickness of the protective layer can range from 10-6000 nm, more preferably about 100 nm. An alternative way for producing the protective layer is by using inkjet printing which is similar to the process described for printing the insulating layer. The material of the insulating layer is a silicon-based or an acrylic-based insulating overcoat material that is printed from the inkjet. The thickness of the protective layer produced by inkjet printing can range from 0.05-7 μm, particularly about 2 μm. FIG. 4 (Step 8) shows the cross-sectional view of the process pattern after this processing step. After protecting the metal circuit region with an insulating ink, the circuit region is bonded to a flexible printed circuit (FPC) to produce the touch panel.

In a non-limiting embodiment, producing a single-sided, multi-layer, touch circuit structure and panel further includes creating patterning on flexible substrates. These flexible substrate can be made from a variety of materials including, but not limited to, glass, poly(methyl methacrylate) (PMMA), polycarbonate (PC), and/or polyethylene terephthalate (PET) film. Furthermore, the substrate can take the form of any shape including, but not limited to, a flat surface substrate or a curved surface substrate.

The selective laser process used to produce a single-sided, multi-layer, touch circuit structure and panel is compatible with a touch manufacturing sheet type process and a cell type process. Additionally, the selective laser process is performed on touch panels having any color and can be used for application in any field of technology.

It should be noted that all figures shown and embodiments disclosed herein are exemplary and should not be viewed as limiting scope of the present subject matter, as depicted in the appended claims.

We claim:

1. A method for manufacturing a single-sided, multi-layer, mutual capacitance touch panel using a selective laser process comprising:
printing artwork on a glass substrate;
applying a first conducting layer on the glass substrate including the artwork;
performing selective laser etching on the first conducting layer, wherein etching the conducting layer creates electrically isolating gaps, and wherein a majority of the conducting layer remains on an un-etched region;
applying an overcoat and a photoresist on the insulating layer;
coating an insulating layer and performing selective laser curing on the overcoat formed on the insulating layer and the photoresist formed on the insulating layer, wherein the selective laser curing cures a specific region of the overcoat and the photoresist without affecting neighboring regions or a material layer located beneath a circuit region;
applying a second conducting layer and/or a plurality of conducting layers on the glass substrate including the first conducting layer and the insulating layer;
performing selective laser etching on the second conducting layer and/or a plurality of conducting layers, wherein a complete touch circuit is produced;
depositing a plurality of metal layers on metal lead regions located at edges of a process pattern;
creating parallel electrically isolating gaps on the second conducting layer and/or a plurality of conducting layers;
performing selective laser etching on the metal lead regions thereby creating patterning for the complete touch circuit; and
applying a protective layer to the complete touch circuit.

2. The method of claim 1, wherein the first conducting layer and at least the second conducting layer are transparent,
wherein the first conducting layer and at least the second conducting layer have a thickness of 10-100 nm, and
wherein the first conducting layer and at least the second conducting layer are configured of conductive materials selected from indium tin oxide (ITO), zinc peroxide (ZnO₂), carbon nanotubes, and silver nanowires, and any conducting material having a comparable electrical conductivity to the electrical conductivity of at least one of ITO, ZnO₂, carbon nanotubes and silver nanowires.

3. The method of claim 1, wherein the first conducting layer includes at least two parallel electrically isolating gaps, and wherein each electrically isolating gap has a length of 0.05-0.5 mm, a width of 0.001-0.3 mm, and a distance between the two parallel gaps of 0.01-0.5 mm.

4. The method of claim 1, further comprising:
forming a plurality of insulating blocks on top of the plurality of the electrically isolating gaps by performing inkjet printing,
wherein each insulating block is configured to have a length of 0.05-1 mm and a width of 0.05-1 mm, and
wherein each insulating block includes a light sensitive insulating photoresist selected from a silicon-based resin, an acrylic-based resin, and any insulating and transparent material for jet-printing; and
exposing each insulating block to a laser, thereby refining the plurality of insulating blocks, wherein each insulating block is configured to have a length of 0.05-0.6 mm, a width of 0.05-0.6 mm, and a thickness of 0.5-5 μm.

5. The method of claim 1, wherein the plurality of metal layers have a thickness of 1-7 μm and are made of a low resistance material selected from silver paste, copper paste, and carbon paste, and any material having a comparable electrical conductivity to at least one of silver paste, copper paste, and carbon paste.

6. The method of claim 1, wherein the protective layer has a thickness of 10-6000 nm, and wherein the protective layer is made of an insulating material.

7. The method of claim 1, wherein the protective layer is manufactured using inkjet printing, has a thickness of 0.05-7 μm, and wherein the protective layer includes a silicon-based or an acrylic-based photoresist insulating material.

8. The method of claim 1, further comprising creating patterning on flexible substrates, wherein the flexible substrate includes at least one of glass, poly(methyl methacrylate) (PMMA), polycarbonate (PC), polyethylene terephthalate (PET) film.

9. The method of claim 1, further comprising creating patterning on a flat surface substrate or a curved surface substrate.

10. The method of claim 1, wherein the selective laser process is compatible with a touch manufacturing sheet type process and a cell type process.

11. The method of claim 1, wherein the selective laser process is performed on touch panels having any color.

12. The method of claim 1, further comprising creating patterning on a transparent substrate made of a conducting material selected from indium tin oxide (ITO), Poly(3,4-ethylenedioxythiophene) (PEDOT), carbon nanotubes, and a nano-silver.

13. The method of claim 1, further comprising using selective laser processing to produce circuits for application in other fields of technology.
